(19) United States
(12) Patent Application Publication
(10) Pub. No.: US 2021/0021743 A1
(43) Pub. Date: Jan. 21, 2021

(54) HANDHELD ELECTRONIC DEVICE AND HEAD MOUNTED ELECTRONIC DEVICE

(71) Applicant: HTC Corporation, Taoyuan City (TW)

(72) Inventors: Chung-Hsiang Chang, Taoyuan City (TW); Meng-Che Tsai, Taoyuan City (TW); Kuei-Chun Liu, Taoyuan City (TW)

(73) Assignee: HTC Corporation, Taoyuan City (TW)

(21) Appl. No.: 16/516,269

(22) Filed: Jul. 19, 2019

(51) Int. Cl. H04N 5/225; G02B 27/28

(52) U.S. Cl. CPC H04N 5/2257; G02B 27/283; H04N 5/2254; H04N 5/2253; H04N 5/2252; G02B 27/286

(57) ABSTRACT

A handheld electronic device includes an optical imaging module, a case and a display device. The optical imaging module is adapted to receive a light beam. The optical imaging module includes a lens group, a linear polarization element, a beam splitting element, two reflection groups and a photosensitive element along an optical axis from an object side to an image side. The optical axis includes a first optical axis and a second optical axis that is not parallel to the first optical axis. The lens group, the linear polarization element, the beam splitting element and the photosensitive element are located on the first optical axis, the two reflection groups and the beam splitting element are located on the second optical axis, and the beam splitting element is disposed between the two reflection groups.

### BACKGROUND OF THE INVENTION

### Technical Field

The present invention relates to an electronic device, and more particularly to a handheld electronic device and a head mounted electronic device.

### Description of Related Art

In recent years, the popularity of portable electronic products such as mobile phones and digital cameras has led to the vigorous development of image module related technologies. The image module mainly includes elements such as an optical imaging lens, a module holder unit and a sensor, and the thin and light trend of mobile phones and digital cameras has also made the demand for miniaturization of image modules increasingly higher. With the technological advancement and downsizing of charge coupled devices (CCDs) and complementary metal oxide semiconductors (CMOSs), optical imaging lenses loaded in image modules also need to be correspondingly reduced in length. However, in order to avoid degradation of photographic effects and quality, good optical performance must be ensured when the length of the optical imaging lens is reduced. The most important feature of an optical imaging lens is nothing more than imaging quality and volume.

However, the manufacturing technology of the miniaturized lens is significantly more difficult than that of the traditional lens. Therefore, how to manufacture an optical imaging lens that meet the needs of consumer electronics products and continue to improve its imaging quality has long been pursued by the production, government and academia in this field. In addition, the short focal length of a wide-angle lens and a fisheye lens makes it difficult to reduce the overall length. The difficulty of reducing the length of the lens and the difficulty of maintaining the imaging quality make the design of the optical imaging lens difficult.

### SUMMARY

The present invention provides an electronic device. The electronic device reduces the total length of a lens such that a wide-angle lens, a fisheye lens or a telephoto lens is mounted in a mobile phone or a thin and light device.

The present invention provides a handheld electronic device, comprising an optical imaging module, a case and a display device. The case and the display device enclose the optical imaging module, a light transmissive member is disposed on one side of the case, and the optical imaging module is adapted to receive a light beam transmitted through the light transmissive member. The optical imaging module comprises a lens group, a linear polarization element, a beam splitting element, two reflection groups and a photosensitive element along an optical axis from an object side to an image side. The optical axis comprises a first optical axis and a second optical axis that is not parallel to the first optical axis. The lens group, the linear polarization element, the beam splitting element and the photosensitive element are located on the first optical axis, the two reflection groups and the beam splitting element are located on the second optical axis, and the beam splitting element is disposed between the two reflection groups. The light beam is reflected by one of the two reflection groups and transmitted through the beam splitting element, and the light beam is reflected by the other of the two reflection groups and reflected by the beam splitting element to the photosensitive element.

The present invention further provides a head mounted electronic device, comprising a plurality of light source detection modules, a case and a display device. The case and the display device enclose the light source detection modules, a plurality of light transmissive members are disposed on at least one side of the case, and the light source detection modules are adapted to correspondingly receive a plurality of light beams transmitted through the light transmissive members. An optical imaging module comprises a lens group, a linear polarization element, a beam splitting element, two reflection groups and a photosensitive element along an optical axis from an object side to an image side. The optical axis comprises a first optical axis and a second optical axis that is not parallel to the first optical axis. The lens group, the linear polarization element, the beam splitting element and the photosensitive element are located on the first optical axis, the two reflection groups and the beam splitting element are located on the second optical axis, and the beam splitting element is disposed between the two reflection groups. The light beam is reflected by one of the two reflection groups and transmitted through the beam splitting element, and the light beam is reflected by the other of the two reflection groups and reflected by the beam splitting element to the photosensitive element.

Based on the above, in the electronic device of the present invention, the optical axis of the optical imaging module or the light source detection modules comprises a first optical axis and a second optical axis that is not parallel to the first optical axis, and the two reflection groups and the beam splitting element are located on the second optical axis. Therefore, after being reflected by the beam splitting element, the light beam is transmitted on the second optical axis by the reflection action of the two reflection groups. Therefore, the optical imaging module or the light source detection modules changes the light beam from being transmitted along the first optical axis to being transmitted along the second optical axis by the beam splitting action of the beam splitting element, and reduces the volume of the optical imaging module or the light source detection modules and the total length of the optical imaging module or the light source detection modules by the action of the two reflection groups.

In order to make the aforementioned and other objectives and advantages of the present invention comprehensible, embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a handheld electronic device according to an embodiment of the present invention.

FIG. 2 is a schematic view of an optical imaging module according to an embodiment of the present invention.

FIG. 3 is a schematic view of an optical imaging module according to another embodiment of the present invention.

FIG. 4 is a schematic view of an optical imaging module according to another embodiment of the present invention.

FIG. 5 is a schematic view of an optical imaging module according to another embodiment of the present invention.

FIG. 6 is a schematic view of a head mounted electronic device according to an embodiment of the present invention.

### DESCRIPTION OF THE EMBODIMENTS

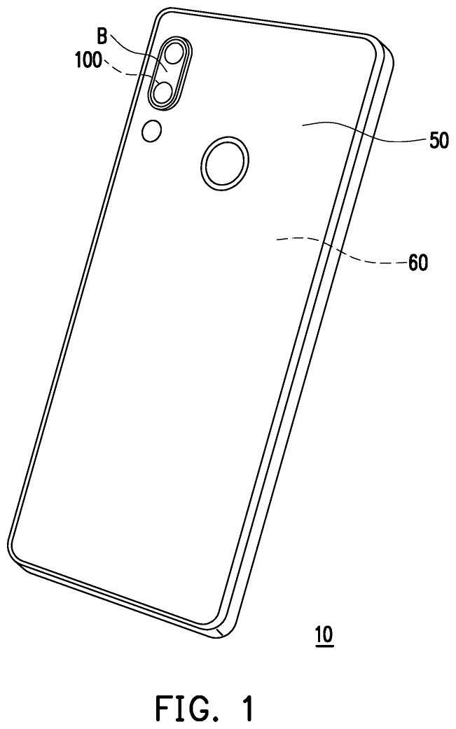

FIG. 1 is a schematic view of a handheld electronic device according to an embodiment of the present invention. Please refer to FIG. 1. An embodiment of the present invention provides a handheld electronic device 10, including an optical imaging module 100, a case 50 and a display device 60. The handheld electronic device 10 is, for example, a mobile phone, the case 50 is, for example, a back case of a mobile phone, and the display device 60 is, for example, a display screen of a mobile phone. The case 50 and the display device 60 enclose the optical imaging module 100, and a light transmissive member B is disposed on one side of the case 50.

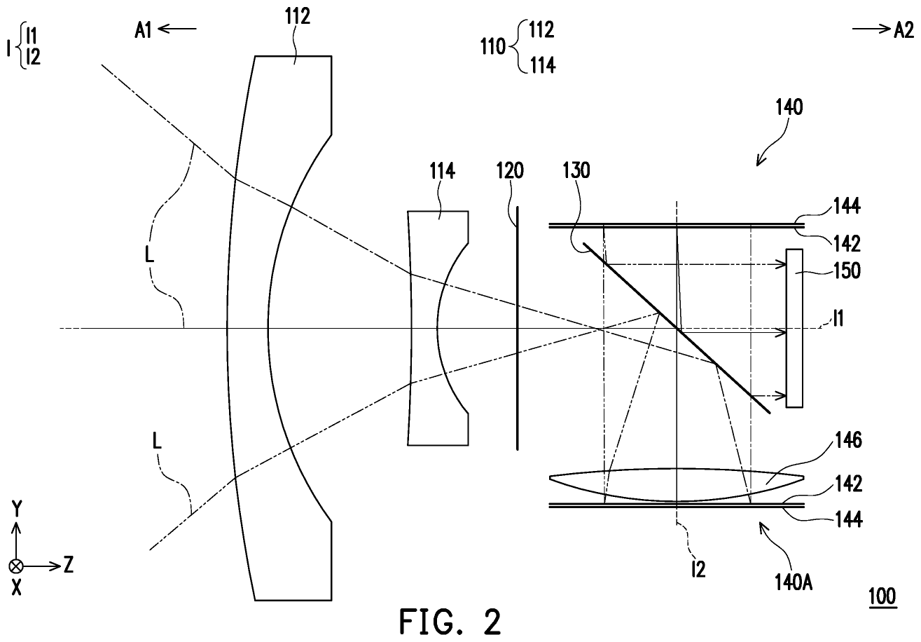

FIG. 2 is a schematic view of an optical imaging module according to an embodiment of the present invention. Please refer to FIG. 2. An embodiment of the present invention provides the optical imaging module 100 that is applied to a head mounted electronic device or a portable electronic device, such as a head mounted VR display device, a notebook computer, a tablet computer, or a mobile phone. Therefore, the following description will take the handheld electronic device 10 applied and shown in FIG. 1 as an example, but the present invention is not limited thereto. The optical imaging module 100 is adapted to receive a light beam L transmitted through the light transmissive member B on the case 50, the light beam is visible light or invisible light, and the light beam L is provided externally, or provided by the electronic device described above and then reflected by any object located in the outside, but the present invention is not limited thereto. In other words, the optical imaging module 100 is composed of a lens module and an imaging member. In the present embodiment, the lens module is a wide-angle lens, a fisheye lens or a telephoto lens, but the present invention is not limited thereto.

In detail, in the present embodiment, the optical imaging module 100 includes a lens group 110, a linear polarization element 120, a beam splitting element 130, two reflection groups 140 and a photosensitive element 150 along an optical axis I from an object side A1 to an image side A2. In other words, the lens module of the optical imaging module 100 is composed of the lens group 110, the linear polarization element 120, the beam splitting element 130 and the two reflection groups 140, and the imaging member of the optical imaging module 100 is composed of the photosensitive element 150. The total length of the optical imaging module 100 is defined as the distance from the surface, facing the object side A1, of the lens group 110 to the surface, facing the image side A2, of the photosensitive element 150. In the present embodiment, the optical path length of the optical imaging module 100 is between 1.1 and 10 times the total length of the optical imaging module 100.

In the present embodiment, the optical axis I includes a first optical axis I1 and a second optical axis I2 that is not parallel to the first optical axis I1. The lens group 110, the linear polarization element 120, the beam splitting element 130 and the photosensitive element 150 are located on the first optical axis I1, and the two reflection groups 140 and the beam splitting element 130 are located on the second optical axis I2. In other words, the beam splitting element 130 is simultaneously located on the first optical axis I1 and the second optical axis I2, and the transmission of the light beam L to the beam splitting element 130 will change the direction of the optical path.

The lens group 110 is disposed on a transmission path of the light beam L on the first optical axis I1. The lens group 110 includes, for example, a combination of one or more optical lenses provided with a diopter, such as various combinations of non-planar lenses including biconcave lenses, biconvex lenses, concavo-convex lenses, convexo-concave lenses, plano-convex lenses, plano-concave lenses, etc. In the present embodiment, the lens group 110 includes a first lens 112 and a second lens 114. However, the present invention does not limit the form or type of the lens group 110.

The linear polarization element 120 is disposed on a transmission path of the light beam L on the first optical axis I1, and located on the light exit side of the lens group 110. The linear polarization element 120 is, for example, a linear polarizer that enables the passing light beam L to produce a linearly polarized state in a single direction. In other words, the light beam L is formed into linearly polarized light after passing through the linear polarization element 120. In some embodiments, the linear polarization element 120 is composed of two linear polarizers which are respectively disposed at different positions, as will be described in other embodiments below. In the present embodiment, the linear polarization element 120 is a single linear polarizer. In the present embodiment, the light beam L is formed into a light beam provided with a linearly polarized state in a first direction after passing through the linear polarization element 120.

The beam splitting element 130 is disposed on a transmission path of the light beam L on the first optical axis I1, and located on the light exit side of the linear polarization element 120, that is, the linear polarization element 120 is located between the lens group 110 and the beam splitting element 130. The beam splitting element 130 is, for example, a polarizing beam splitter (PBS), which enables the light beam L of one specific polarization direction to pass and reflects the light beam L of the other specific polarization direction. In the present embodiment, the beam splitting element 130 is adapted to enable the light beam L provided with the first linear polarization direction to pass and adapted to reflect the light beam L provided with the second linear polarization direction. The first linear polarization direction is different from the second linear polarization direction.

The two reflection groups 140, 140A are disposed on the transmission path of the light beam L on the second optical axis I2, and the beam splitting element 130 is located between the two reflection groups 140, 140A. One of the two reflection groups 140, 140A is adapted to reflect the light beam L so that the light beam L is transmitted through the beam splitting element 130, and the other of the two reflection groups 140, 140A is adapted to reflect the light beam L so that the light beam L is transmitted to the beam splitting element 130 and reflected by the beam splitting element 130 to the photosensitive element 150. In detail, in the present embodiment, the reflection group 140 located at the upper side of FIG. 2 includes a quarter-wave plate 142 and a reflective element 144. The reflective element 144 is, for example, a reflector. The reflection group 140A located at the lower side of FIG. 2 is similar to the reflection group 140 at the upper side of FIG. 2, except that the reflection group 140A located at the lower side of FIG. 2 further includes at least one lens 146 provided with a diopter, and the at least one lens 146 is located between the beam splitting element 130 and the quarter-wave plate 142 of the reflection group 140A. In the present embodiment, the number of the lenses 146 is, for example, one, but the present invention is not limited thereto.

The photosensitive element 150 is disposed on a transmission path of the light beam L on the first optical axis I1, and the beam splitting element 130 is located between the linear polarization element 120 and the photosensitive element 150. The photosensitive element 150 is adapted to receive the light beam L to produce image data. The photosensitive element 150 is, for example, a charge coupled device (CCD) or a complementary metal oxide semiconductor transistor (CMOS), and the present invention is not limited thereto.

When the light beam L enters the optical imaging module 100 from the outside along the first optical axis I1, the light beam L is transmitted through the lens group 110 and the linear polarization element 120, and the light beam L transmitted through the linear polarization element 120 has a linearly polarized state in the first direction. The light beam L provided with a linearly polarized state in the first direction is transmitted to the beam splitting element 130, and the light beam L is transmitted along the second optical axis I2 via the reflection of the beam splitting element 130 to the reflection group 140A located at the lower side of FIG. 2. Specifically, the light beam L is sequentially transmitted by the beam splitting element 130 through the lens 146 and the quarter-wave plate 142 to the reflective element 144, and is transmitted again through the quarter-wave plate 142 and the lens 146 via the reflection of the reflective element 144 and transmitted through the beam splitting element 130. Therefore, the light beam L is transmitted to the reflective element 144 by the beam splitting element 130, and then transmitted back to the beam splitting element 130 after being reflected, and transmitted through the quarter-wave plate 142 and the lens 146 twice respectively. In other words, the lens 146 in the reflection group 140A enables the light beam L to pass to produce the optical effect twice. Thus, the at least one lens 146 provided with a diopter configured in the reflection group 140A reduces the number of lenses used in the optical imaging module 100, thereby reducing the volume.

On the other hand, since the light beam L passes through the quarter-wave plate 142 twice and is reflected by the reflective element 144, the light beam L reflected by the reflective element 144 and passing the quarter-wave plate 142 has a linear polarized state in a second direction perpendicular to the first direction. Therefore, the light beam L provided with a linearly polarized state in the second direction is transmitted to the reflection group 140 located at the upper side of FIG. 2 through the beam splitting element 130. Similarly, in the reflection group 140 located at the upper side of FIG. 2, the light beam L is transmitted through the quarter-wave plate 142 by the beam splitting element 130 to the reflective element 144, and is reflective by the reflective element 144 to pass through the quarter-wave plate 142 again and transmitted to the beam splitting element 130. Since the light beam L passes through the quarter-wave plate 142 twice and is reflected by the reflective element 144, the light beam L which is reflected by the reflective element 144 and then passes through the quarter-wave plate 142 has a linear polarized state in the first direction. Therefore, the light beam L provided with a linearly polarized state in the first direction is transmitted to the beam splitting element 130 to be reflected and transmitted to the photosensitive element 150.

Thus, the optical imaging module 100 changes the light beam L from being transmitted along the first optical axis I1 to being transmitted along the second optical axis I2 by the beam splitting action of the beam splitting element 130, and reduces the volume of the optical imaging module 100 and the total length of the optical imaging module 100 by the action of the two reflection groups 140, 140A. In other words, a wide-angle lens, a fisheye lens or a telephoto lens is more easily mounted in a thin and light mobile phone or other thin and light devices.

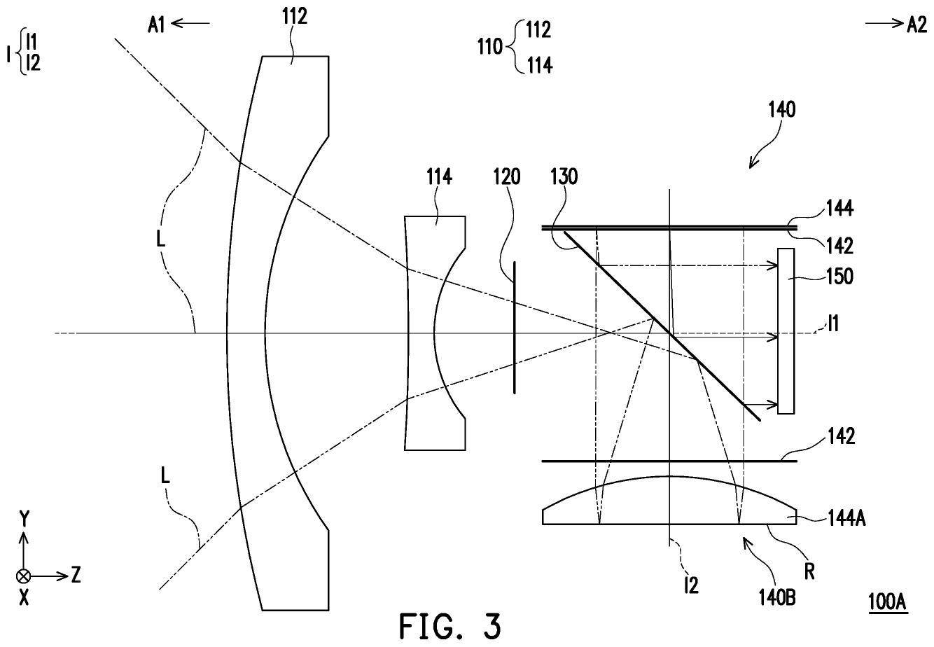

FIG. 3 is a schematic view of an optical imaging module according to another embodiment of the present invention. Please refer to FIG. 3. The optical imaging module 100A of the present embodiment is similar to the optical imaging module 100 of the embodiment of FIG. 2. The difference between the two is that, in the present embodiment, a reflective element 144A of a reflection group 140B located at the lower side of FIG. 2 includes a lens provided with a diopter and a reflective coating R in place of the reflector of the embodiment of FIG. 2. Furthermore, the quarter-wave plate 142 is disposed between the beam splitting element 130 and the reflective element 144A. For example, in the present embodiment, the reflective element 144A is, for example, a convexo-plane lens, and the reflective coating R is formed on the light exit side (planar surface).

Therefore, when the light beam L is transmitted along the second optical axis I2 via the reflection of the beam splitting element 130 to the reflection group 140B located at the lower side of FIG. 3, the light beam L is transmitted from the beam splitting element 130 through the quarter-wave plate 142 to the reflective element 144A, and is transmitted through the quarter-wave plate 142 again through the reflection of the reflective element 144A and transmitted through the beam splitting element 130. In other words, the light beam L is transmitted by the beam splitting element 130 and reflected by the reflective element 144A, and then transmitted back to the beam splitting element 130 after reflection, and transmitted through the quarter-wave plate 142 twice and the lens of the reflective element 144A twice respectively. Thus, in the reflection group 140B, the light exit side of the lens provided with a diopter is combined with the reflective coating R to serve as the reflective element 144A, which reduces the number of lenses used by the optical imaging module 100A and the number of elements located on the second optical axis I2, thereby reducing the volume and the optical path length of the optical imaging module 100A. In other words, a wide-angle lens, a fisheye lens or a telephoto lens is more easily mounted in a thin and light mobile phone or other thin and light devices.

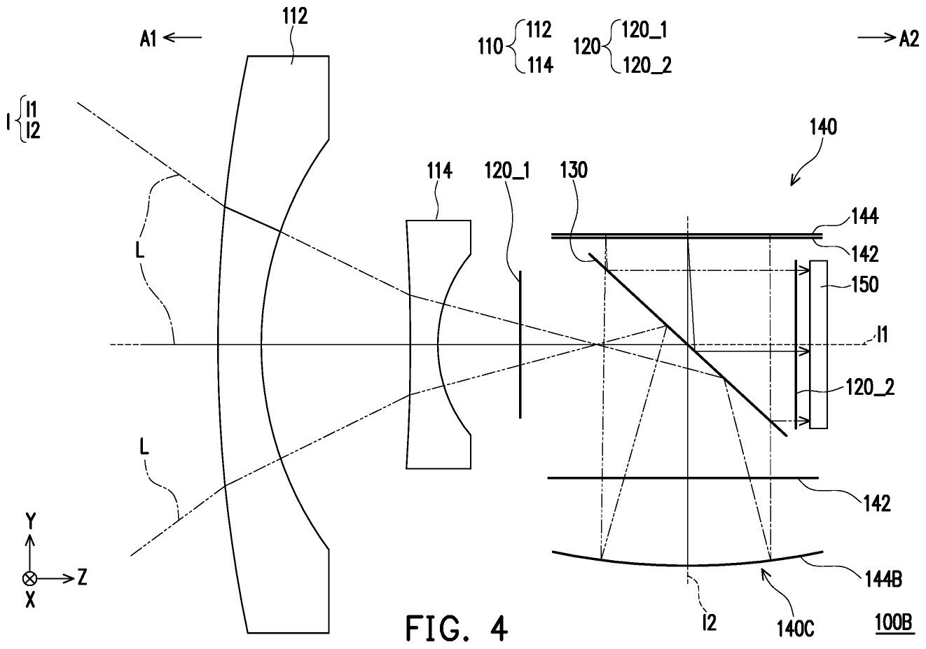

FIG. 4 is a schematic view of an optical imaging module according to another embodiment of the present invention. Please refer to FIG. 4. The optical imaging module 100B of the present embodiment is similar to the optical imaging module 100 of the embodiment of FIG. 2. The difference between the two is that, in the present embodiment, the linear polarization element 120 includes a first linear polarization element 120_1 and a second linear polarization element 120_2, that is, the linear polarization element 120 is composed of two linear polarizers. The first linear polarization element 120_1 is disposed between the lens group 110 and the beam splitting element 130, and the second linear polarization element 120_2 is disposed between the beam splitting element 130 and the photosensitive element 150. Therefore, after the light beam L passes through the two reflection groups 140, 140C, stray light is filtered out through the second linear polarization element 120_2, thereby further improving the good optical effect.

Further, in the present embodiment, a reflective element 144B of the reflection group 140C located at the lower side of FIG. 4 includes a curved mirror in place of the reflector of the embodiment of FIG. 2. Further, the quarter-wave plate 142 is disposed between the beam splitting element 130 and the reflective element 144B. For example, in the present embodiment, the reflective element 144B is, for example, a concave mirror.

Therefore, when the light beam L is transmitted along the second optical axis I2 via the reflection of the beam splitting element 130 to the reflection group 140C located at the lower side of FIG. 4, the light beam L is transmitted from the beam splitting element 130 through the quarter-wave plate 142 to the reflective element 144B, and is transmitted through the quarter-wave plate 142 again through the reflection of the reflective element 144B and transmitted through the beam splitting element 130. In other words, the light beam L is transmitted to the reflective element 144B by the beam splitting element 130, and then transmitted back to the beam splitting element 130 after reflection, and transmitted through the quarter-wave plate 142 twice and the lens of the reflective element 144B twice respectively. Thus, in the reflection group 140C, the curved mirror provided with a diopter serves as the reflective element 144B, which reduces the number of lenses used by the optical imaging module 100B and the number of elements located on the second optical axis I2, thereby reducing the volume and the optical path length of the optical imaging module 100B. In other words, a wide-angle lens, a fisheye lens or a telephoto lens is more easily mounted in a thin and light mobile phone or other thin and light devices.

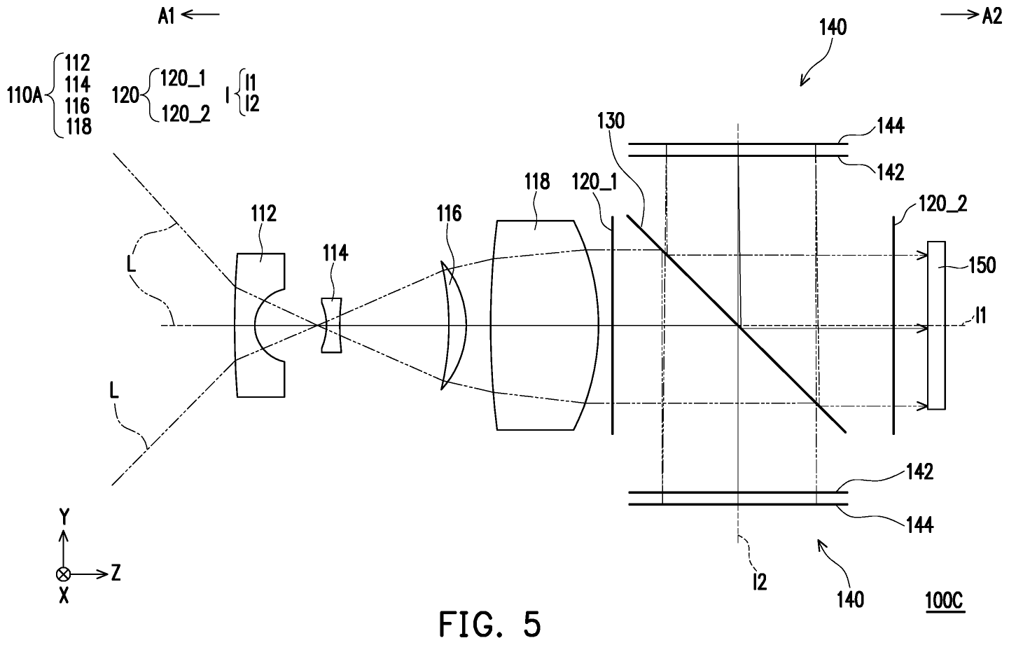

FIG. 5 is a schematic view of an optical imaging module according to another embodiment of the present invention. Please refer to FIG. 5. The optical imaging module 100C of the present embodiment is similar to the optical imaging module 100 of the embodiment of FIG. 2. The difference between the two is that, in the present embodiment, a lens group 110A further includes a third lens 116 and a fourth lens 118. Moreover, in the present embodiment, the two reflection groups 140 are substantially identical, each including the quarter-wave plate 142 and the reflective element 144, and the reflective element 144 is a plane mirror.

Therefore, when the light beam L is transmitted along the second optical axis I2 via the reflection of the beam splitting element 130 to the reflection group 140 located at the lower side of FIG. 5, the light beam L is transmitted from the beam splitting element 130 through the quarter-wave plate 142 to the reflective element 144, and is transmitted through the quarter-wave plate 142 again through the reflection of the reflective element 144 and transmitted through the beam splitting element 130. In other words, the light beam L is by the beam splitting element 130 to the reflective element 144, and then transmitted back to the beam splitting element 130 after reflection, and transmitted through the quarter-wave plate 142 twice. Thus, the volume of the optical imaging module 100C is reduced and the optical path length is reduced. In other words, a wide-angle lens, a fisheye lens or a telephoto lens is more easily mounted in a thin and light mobile phone or other thin and light devices.

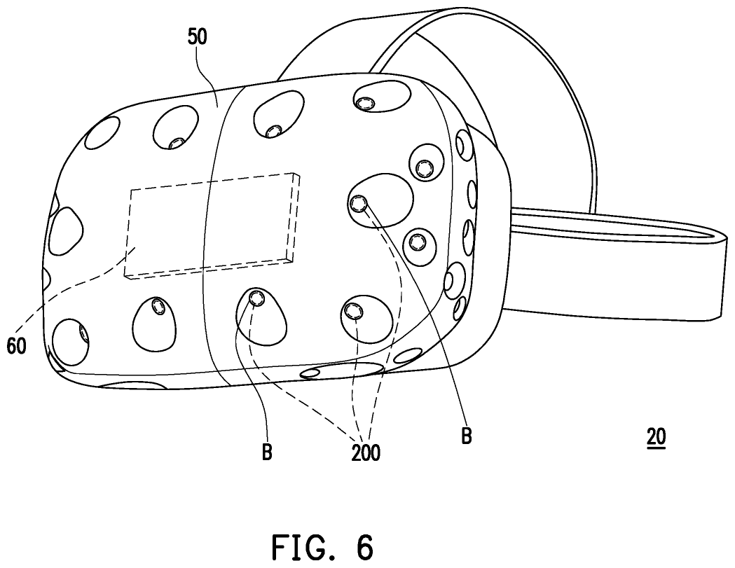

FIG. 6 is a schematic view of a head mounted electronic device according to an embodiment of the present invention. Please refer to FIG. 6. An embodiment of the present invention provides the head mounted electronic device 20, including a plurality of optical detection modules 200, a case 50 and a display device 60. The head mounted electronic device 20 is, for example, a head mounted VR display device, and the case 50 is, for example, a back case, wherein a display module is disposed in the head mounted device, and the display device 60 is, for example, a display module in the head mounted device. The case 50 and the display device 60 enclose the plurality of optical detection modules 200, and a plurality of light transmissive members B are disposed on one side of the case 50. The plurality of light source detection modules 200 are adapted to correspondingly receive a plurality of light beams transmitted through the plurality of light transmissive members B (see the light beams L of FIG. 2). In the present embodiment, the plurality of light source detection modules 200 use the optical imaging modules 100, 100A, 100B, 100C shown in FIG. 2 to FIG. 5 as needed. Detailed steps and implementations of the light source detection modules 200 receiving the light beams L for light source detection are sufficiently taught, suggested, and implemented by the general knowledge in the art, and thus will not be described again.

In an embodiment, the positions of the light source detection modules 200 are, for example, disposed at two opposite ends of the case 50 in the head mounted electronic device 20. In another embodiment, the positions of the light source detection modules 200 are disposed on the case 50, for example, by surrounding the case 50 of the light source detection modules 200. In the present embodiment, the light source detection modules 200 are respectively disposed in a manner of facing different directions to correspondingly receive the light beams L from different directions, as shown in FIG. 6. Thus, reducing the volume of the light source detection modules 200 and reducing the total length of the light source detection modules 200 enable the head mounted electronic device 20 to have more possibilities for light source detection directions, thereby improving the good optical quality.

It should be noted that the plurality of light beams received by the light source detection modules 200 in the head mounted electronic device 20 is provided by at least one light emitting device, and the light emitting device is disposed, for example, on an optical base station, but the present invention is not limited thereto. The light beam provided by the light emitting device is, for example, infrared light, or X-ray, visible blue light, ultraviolet light or ambient light subjected to a specific filtering process, and the present invention is not limited thereto. Therefore, the light source detection modules 200 in the head mounted electronic device 20 receive the light beam provided by the light emitting device and transmitted to the light source detection modules 200 through the reflection of the surrounding object.

Based on the above, in the electronic device of the present invention, the optical axis of the optical imaging module or the light source detection modules includes the first optical axis and the second optical axis that is not parallel to the first optical axis, and the two reflection groups and the beam splitting element are located on the second optical axis. Therefore, after being reflected by the beam splitting element, the light beam is transmitted on the second optical axis by the reflection action of the two reflection groups. Thus, the optical imaging module or the light source detection modules changes the light beam from being transmitted along the first optical axis to being transmitted along the second optical axis by the beam splitting action of the beam splitting element, and reduces the volume of the optical imaging module or the light source detection modules and the total length of the optical imaging module or the light source detection modules by the action of the two reflection groups.

Although the invention is described with reference to the above embodiments, the embodiments are not intended to limit the invention. A person of ordinary skill in the art may make variations and modifications without departing from the spirit and scope of the invention. Therefore, the protection scope of the invention should be subject to the appended claims.

1. A handheld electronic device, comprising an optical imaging module, a case and a display device, the case and the display device enclosing the optical imaging module, a light transmissive member being disposed on one side of the case, the optical imaging module being adapted to receive a light beam transmitted through the light transmissive member, the optical imaging module comprising a lens group, a linear polarization element, a beam splitting element, two reflection groups and a photosensitive element along an optical axis from an object side to an image side, the optical axis comprising a first optical axis and a second optical axis that is not parallel to the first optical axis, wherein the lens group, the linear polarization element, the beam splitting element and the photosensitive element are located on the first optical axis, the two reflection groups and the beam splitting element are located on the second optical axis, the beam splitting element is disposed between the two reflection groups, the light beam is reflected by one of the two reflection groups and transmitted through the beam splitting element, and the light beam is reflected by the other of the two reflection groups and reflected by the beam splitting element to the photosensitive element, wherein the light beam is a focused beam when it passes into the beam splitting element.

2. The handheld electronic device according to claim 1, wherein the beam splitting element is a polarizing beam splitter.

3. The handheld electronic device according to claim 1, wherein each of the two reflection groups comprises a quarter-wave plate and a reflective element.

4. The handheld electronic device according to claim 3, wherein at least one of the two reflection groups further comprises at least one lens provided with a diopter, located between the beam splitting element and the quarter-wave plate.

5. The handheld electronic device according to claim 3, wherein the reflective element of at least one of the two reflection groups comprises a lens provided with a diopter and a reflective coating, and the quarter-wave plate is located between the beam splitting element and the reflective element.

6. The handheld electronic device according to claim 3, wherein the reflective element of at least one of the two reflection groups comprises a curved mirror, and the quarter-wave plate is located between the beam splitting element and the reflective element.

7. The handheld electronic device according to claim 3, wherein the reflective element of at least one of the two reflection groups comprises a plane mirror, and the quarter-wave plate is located between the beam splitting element and the reflective element.

8. The handheld electronic device according to claim 1, wherein the linear polarization element comprises a first linear polarization element and a second linear polarization element, the first linear polarization element is located between the lens group and the beam splitting element, and the beam splitting element is located between the first linear polarization element and the second linear polarization element.

9. The handheld electronic device according to claim 1, wherein the lens group, the linear polarization element, the beam splitting element and the two reflection groups are formed as a wide-angle lens, a fisheye lens or a telephoto lens.

10. A head mounted electronic device, comprising a plurality of optical detection modules, a case and a display device, the case and the display device enclosing the optical detection modules, a plurality of light transmissive members being disposed on at least one side of the case, the optical detection modules being adapted to correspondingly receive a plurality of light beams transmitted through the light transmissive members, each of the optical detection modules comprising a lens group, a linear polarization element, a beam splitting element, two reflection groups and a photosensitive element along an optical axis from an object side to an image side, the optical axis comprising a first optical axis and a second optical axis that is not parallel to the first optical axis, wherein the lens group, the linear polarization element, the beam splitting element and the photosensitive element are located on the first optical axis, the two reflection groups and the beam splitting element are located on the second optical axis, the beam splitting element is disposed between the two reflection groups, the light beam is reflected by one of the two reflection groups and transmitted through the beam splitting element, and the light beam is reflected by the other of the two reflection groups and reflected by the beam splitting element to the photosensitive element, wherein the light beam is a focused beam when it passes into the beam splitting element.

11. The head mounted electronic device according to claim 10, wherein the optical detection modules are disposed on two opposite ends of the case.

12. The head mounted electronic device according to claim 10, wherein the optical detection modules are disposed on the case by surrounding the case.

13. The head mounted electronic device according to claim 10, wherein the optical detection modules are disposed on the case, and the optical detection modules are respectively disposed in a manner of facing different directions to correspondingly receive the light beams from different directions.
